(19) United States
(12) Patent Application Publication
(10) Pub. No.: US 2004/0226210 A1
(43) Pub. Date: Nov. 18, 2004

(54) Display and storage device

(76) Inventor: Jasinta Kaur, Aurora (CA)

Correspondence Address: DENNISON ASSOCIATES, 133 RICHMOND STREET WEST, SUITE 301, TORONTO, ON, M5H 2L7, CA

(21) Appl. No.: 10/825,660

(22) Filed: Apr. 16, 2004

Related U.S. Application Data
(60) Provisional application No. 60/463,686, filed on Apr. 18, 2003.

(51) Int. Cl. G09F 7/00

(52) U.S. Cl. 40/725; 40/606.08

(57) ABSTRACT

A display and storage device for pictures, photographs, drawings and other artwork and printed matter, and more particularly a display and storage device that serves as a decorative or functional piece of furniture. The device comprises a body member having a plurality of walls for forming at least one inner cavity and at least one access port. The inner cavity is adapted to removeably receive and store a series of panels. Pictures, photographs, drawings and other artwork and printed matter are removeably mounted onto at least one face of each panel. The panels are inserted into the inner cavity of the body member through the access port in a vertical or horizontal orientation, and can be removed from the inner cavity through an access port for viewing or for interchanging the panel sequence. At least one wall of the body member is adapted to display the panels together with their mounted pictures, photographs, drawings and other artwork and printed matter.

This invention claims priority of and is related to U.S. Provisional Application entitled PHOTOGRAPH DISPLAY AND STORAGE DEVICE filed on Apr. 18, 2003.

### FIELD OF THE INVENTION

The present invention relates to a device for displaying and storing pictures, photographs, drawings and other artwork and printed matter, and more particularly, relates to a storage and display device that also serves as a decorative or functional piece of furniture.

### BACKGROUND OF THE INVENTION

Traditionally, picture frames or albums are used to display or store pictures, photographs, drawings and other artwork and printed matter. However, conventional picture frames can display only one item at a time. Also, it is not easy to change an item within the picture frame. Although conventional albums allow for a large number of pictures, photographs and the like to be stored, albums are difficult to display and are typically concealed or stowed in a drawer or shelf. Thus, conventional albums are not readily accessible as the album must be located and retrieved before viewing.

In addition, conventional picture frames and albums cannot easily accommodate a variety of different-sized pictures, photographs, drawings and the like.

### SUMMARY OF THE INVENTION

The combined display and storage device of the present invention has the ability to store and display a large number of pictures, photographs, drawings and other artwork and printed matter, while additionally defining a decorative or functional piece of furniture. The device displays and stores a number of pictures, photographs, drawings and other artwork and printed matter, in an accessible, organized and decorative manner. The device has the ability to display and store pictures, photographs, drawings and other artwork and printed matter that are of a variety of sizes. The device also has the ability to easily change the display arrangement of the pictures, photographs, drawings and other artwork and printed matter in a convenient manner. In addition, the display and storage device, due to its additional furniture function, can be placed in any location for easy accessibility.

In accordance with one aspect of the present invention, a display and storage device comprises a body member having a plurality of walls, which define at least one inner cavity and at least one access port. A cover, which is positioned on the body member to cover an access port, can be provided. The inner cavity is adapted to removeably receive and store a series of self-supporting panels. The panels are inserted into an inner cavity of the body member through the access port. In an embodiment of the invention, the panels are inserted into the inner cavity and stored in a vertical orientation. In another embodiment of the invention, the panels are inserted into the inner cavity and stored in a horizontal orientation. The panels are removed from the inner cavity of the body member through the access port for viewing the panels or for interchanging the panel sequence. A plurality of artwork, which includes pictures, photographs, drawings and other artwork and printed matter, are removeably mounted onto at least one face of each panel. The pictures, photographs, drawings and other artwork and printed matter can be a variety of sizes.

In an aspect of the invention, at least one wall of the body member is adapted to display a stored panel together with its mounted pictures, photographs, drawings and other artwork and printed matter. Preferably, at least one wall of the body member is a transparent material, which permits the display of a stored panel there through. In a further aspect of the invention, at least one wall is adapted to slideably receive and hold a panel for display.

In yet a further aspect of the invention, the cover is similarly adapted to display a stored panel together with its mounted pictures, photographs, drawings and other artwork and printed matter. Preferably, the cover is comprised of a transparent material, which permits the display of a panel stored in the cavity immediately below the cover. In yet a further aspect of the invention, the cover is adapted to slideably receive and hold a panel for display.

### BRIEF DESCRIPTION OF THE DRAWINGS

Preferred embodiments of the invention are shown in the drawings, wherein:

FIG. 1 is a perspective view of one embodiment of the display and storage device showing the cover wall in the closed position; in accordance with the present invention;

FIG. 2 is an exploded perspective view of the display and storage device with one panel in a fully inserted position and a second panel in a removed position;

FIGS. 3 and 3A are perspective views of an alternate embodiment of the display and storage device, with the cover removed;

FIG. 4 is a partial exploded perspective view of an alternate embodiment of FIG. 3, showing two panels in a removed position;

FIG. 5 is a partial exploded perspective view showing the arrangement of the panels in the alternate embodiment;

FIG. 6 is a perspective view of a further embodiment of the display and storage device in the form of a table, with the cover removed;

FIG. 7 is a partial perspective view of one form of a panel; and

FIG. 8 is a partial perspective view showing an alternate form of the panel.

### DETAILED DESCRIPTION OF THE PREFERRED EMBODIMENTS

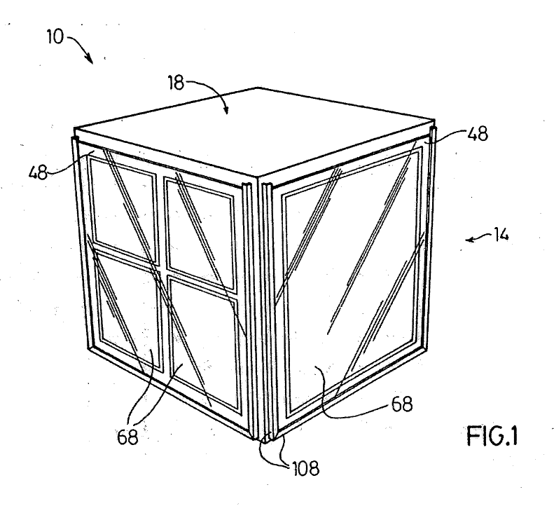

The display and storage device 10 generally comprises a body member 14 and an optional cover member 18. The body member 14 has at least one inner cavity 22 having at least one access port 26. In an embodiment of the invention as shown in FIGS. 1 to 6, the display and storage device serves as a functional or decorative table, which can be used as a side or coffee table, wherein the dimensions of the display and storage device are preferably conventional sized living room tables, such as 18 inches×18 inches×18 inches. It can be appreciated that larger dimensions and different shapes will also work satisfactorily to meet the artwork storage and display function in combination with the table function.

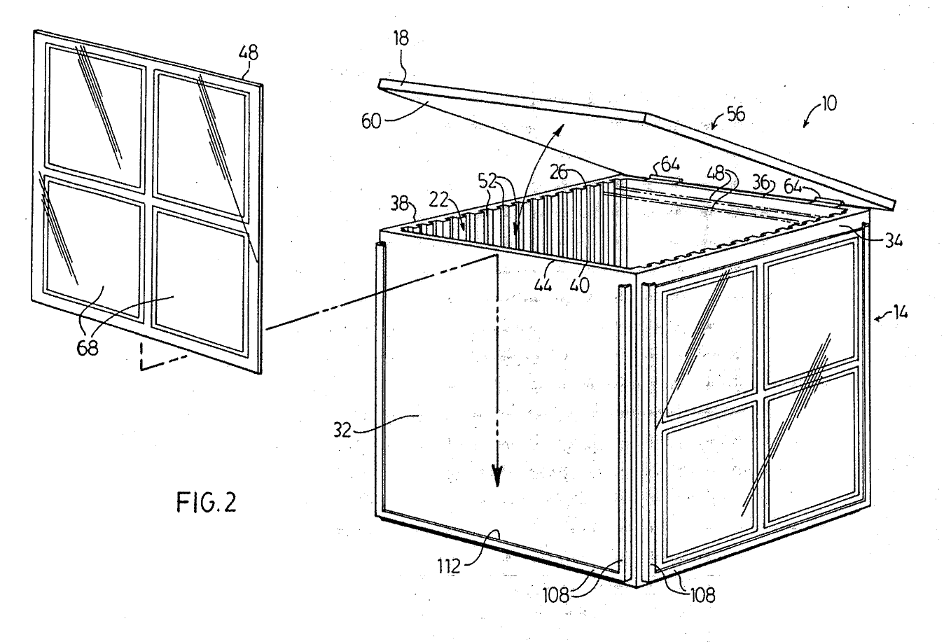

A first embodiment of a display and storage device 10, in accordance with the present invention, is shown in FIGS. 1 and 2. The body member 14 comprises a first wall 30, a second wall 32, a third wall 34, a fourth wall 36, and a fifth wall 38, wherein walls 32 to 38 have a proximal end and a distal end. The first wall 30 forms the base wall of the display and storage device, and the walls 32 to 38 form the side walls, wherein the proximal ends of walls 32 to 38 are affixed by conventional means to the first wall 30 to form an open-ended box-like cavity. Alternatively, the walls 30 to 38 can be fabricated using a conventional molding process using a plastic material to form an open-ended box-like cavity. The walls 30 to 38 each comprise of an inner surface area 40 and an outer surface area 44. The inner cavity 22 of body member 14 is defined by the inner surface areas 40 of walls 30 to 38. The distal ends of walls 32 to 38 define the perimeter of the access port 26.

In addition, it can be appreciated that the body member 14 can be provided in a variety of shapes. Thus, the shape chosen for the body member 14 will determine the number of walls required. The outer shape defines a functional table or storage chest and can be designed to integrate with different decors.

The body member 14 can be made of any suitable stiff material, such as wood, plastic or glass, or a combination thereof. Preferably, at least one of the walls 30 to 38 of body member 14 is fabricated using a transparent material, such as glass or acrylic. The transparent material creates a window to allow the display of a panel 48 stored below the window. As an alternative to a transparent window, the body member can include a framed port with a stored panel displayed within the framed port.

As shown in FIG. 2, a series of parallel grooves 52 are provided in the inner surface area 40 of wall 34 of the body member 14, with matching grooves 52 provided in the inner surface area 40 of the opposing wall 38 of the body member 14. However, it can be appreciated that matching grooves 52 can be provided in the inner surface area 40 of any two walls 32 to 38 that are in a face-to-face relationship. A series of grooves 52 are cut into the inner surface area 40 of the walls 34 and 38 of the body member 14, wherein the grooves 52 preferably extend the length of the wall, namely from the edge of the access port 26 to a point close to the edge of the proximal end of the wall. Alternatively, using a conventional molding process using a plastic material, a series of grooves 52 are molded into the inner surface area 40 of the walls 34 and 38 of the body member 14. Groove 52 is preferably about 0.5 inches in width, although widths in the range of 0.2 inches to 0.7 inches can be used. It is to be understood that the width of the groove 52 is dependent on the thickness of panel 48, in order to create a relatively good fit between the panel and the groove 52 to allow the panel 48 to slide easily into the groove 52 and be securely supported by the groove 52. Groove 52 is preferably about 0.25 inches in depth, although depths in the range of 0.1 inches to 0.5 inches can be used. Each pair of matching grooves 52 slideably receives and supports a panel 48 in the vertical orientation. Opposing edge portions of the panel 48 engage the grooves 52 to support the panel 48, wherein the panel is sufficiently stiff to be self-supporting.

Other arrangements for supporting the panels 48 in the cavity are possible. For example, the edge of the panels 48 could be provided with grooves and the inner surface area 40 of the wall of the body member walls could be provided with support pins or ribs. The important aspect is the organized support of the panels 48 in the inner cavity 22.

Cover member 18 having an external surface area 56 and an internal surface area 60 is provided. The cover 18 preferably has the same dimensions as the walls 30 to 38 of body member 14, although larger dimensions and different shapes will work satisfactorily. As shown in FIGS. 1 and 2, cover member 18 can be positioned on the body member 14 over the access port 26 of inner cavity 22, wherein the internal surface area 60 of cover member 18 abuts the distal ends of walls 32 to 38. Cover member 18 is preferably hingedly attached 64 to a wall of body member 14 by conventional means, such as a hinge. Alternatively, conventional attachment means, such as magnets or hooks, can be provided to removeably attach the cover member 18 to the body member 14. When the cover member 18 is in the open position as illustrated in FIG. 2, access to the panels 48 stored in the inner cavity 22 is provided via the access port 26. When the cover member 18 is in the closed position as illustrated in FIG. 1, the internal surface area 60 of cover member 18 abuts the distal ends of walls 32 to 38. In the closed position, as shown in FIG. 1, the device serves as a table wherein the external surface area 56 of cover 18 serves as the tabletop for the table. The relatively good fit or closure capability of the cover 18 with access port 26 reduces dust contamination of the stored panels 48.

The cover member 18 can be made of any suitable stiff material such as metal, wood, plastic or glass. Preferably, the cover member 18 is comprised of a transparent material, such as glass or acrylic. The transparent material creates a window to allow the display of a panel 48 stored below the window. As an alternative to a transparent window, the cover member can include a framed port with a stored panel displayed within the framed port.

As shown in FIGS. 1 and 2, three L-shaped ribs 108 are permanently mounted to the outer surface area 44 of each of walls 32, 34, 36 and 38, wherein the ribs 108 preferably extend outwardly from the outer surface area 44 and are positioned parallel to three contiguous sides of the wall to define a U-shaped panel holding means 112. The panel holding means 112 slideably receives and holds a panel 48 for displaying the panel 48 together with its mounted artwork 68, which includes pictures, photographs, drawings and other artwork and printed matter. The length of each rib 108 is preferably 15 inches, but it is to be understood that the dimensions of the ribs 108 and the resulting panel holding means 112 correspond to the dimensions of the panel 48. Ribs 108 are preferably constructed from a material similar to the material used in constructing the body member 14. However, this is not limiting and other materials are considered within the scope of the invention. It can be appreciated that the panels 48, which fit into grooves 52, can also fit into the panel holding means 112. However, it can be appreciated that specialized panels, which are similar in construction to the panels 48, can be constructed for exclusive use with the panel holding means 112. In a further aspect of the invention, the panel holding means 112 can be permanently mounted to the external surface area 56 of cover member 18, for slideably receiving and holding a panel 48 for display together with its mounted artwork 68.

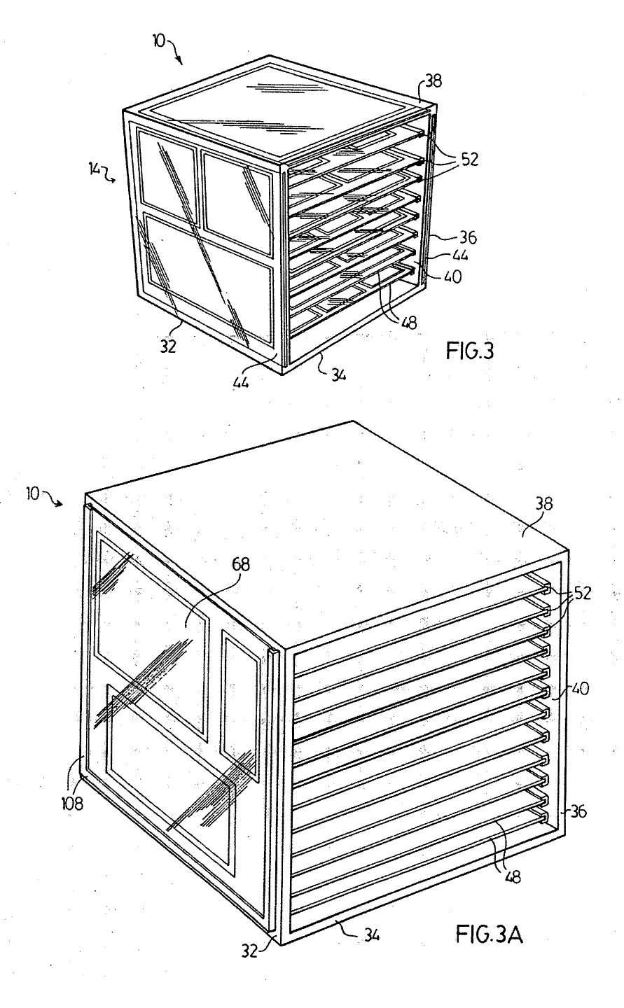

A second embodiment of a display and storage device 10 is shown in FIGS. 3, 3A, 4 and 5. The body member 14 comprises a first wall 30, a second wall 32, a third wall 34, a fourth wall 36, and a fifth wall 38. The third wall 34 forms the base wall, the first wall 30 forms the back wall, walls 32 and 36 form the side walls, and wall 36 forms the top wall of the display and storage device, wherein the walls are affixed together by conventional means to form an open-ended box-like cavity. Alternatively, the walls 30 to 38 are fabricated using a conventional molding process using a plastic material. The walls 30 to 38 each comprise of an inner surface area 40 and an outer surface area 44. The inner cavity 22 of body member 14 is defined by the inner surface areas 40 of walls 30 to 38. In addition, it can be appreciated that the body member 14 can be provided in a variety of shapes. Thus, the shape chosen for the body member 14 will determine the number of walls required.

The body member 14 can be made of any suitable material such as wood, plastic or glass, or a combination of these materials. Preferably, at least one of the walls 30 to 38 of body member 14 is fabricated using a transparent material, such as glass or acrylic. The transparent material creates a window to allow the display of a panel 48 stored below the window. As an alternative to a transparent window, the body member can include a framed port with a stored panel displayed within the framed port.

As shown in FIGS. 3A, 4, and 5, a series of parallel grooves 52 are provided on the inner surface area 40 of wall 32 of the body member 14, with matching grooves 52 provided on the inner surface area 40 of the opposing wall 36 of the body member 14. Each groove 52 is defined by two substantially parallel, spaced apart ribs 53 and 54, which are permanently affixed by conventional means to the inner surface area 40 of the walls 32 and 36. The ribs 53 and 54 preferably extend outwardly from the inner surface area 40 and extend the length of the wall, namely from the edge at the access port 26 to a point close to the edge of the proximal end of the wall. Alternatively, using a conventional molding process using a plastic material, a series of paired ribs 53 and 54 are molded onto the inner surface area 40 of the walls 32 and 36 of the body member 14. Groove 52 is preferably about 0.5 inches in width, although widths in the range of 0.2 inches to 0.7 inches can be used, and it is to be understood that this width is dependent on the thickness of panel 48. Groove 52 is preferably about 0.25 inches in depth, although depths in the range of 0.1 inches to 0.5 inches can be used.

Each pair of matching grooves 52 slideably receives and supports a panel 48, wherein the panel is positioned in the horizontal orientation. Opposing edge portions of the panel 48 engage the grooves 52 to support the panel 48, wherein the panel has sufficient stiffness to be self-supporting in the horizontal orientation.

Other arrangements for supporting the panels 48 in the cavity are possible. For example, the edges of the panels 48 could be provided with grooves and the inner surface area 40 of the walls of the body member 14 could be provided with support pins or ribs. For example, the edges of the panels 48 could be supported by support pins located on the inner surface area 40 of the walls of the body member 14. The important aspect is the organized support of the panels 48 in the inner cavity 22.

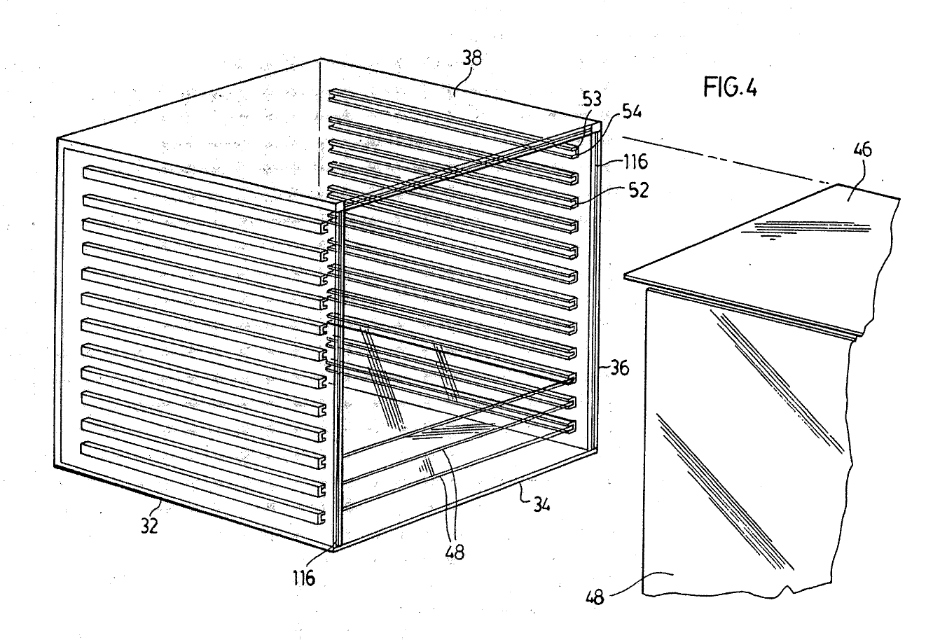

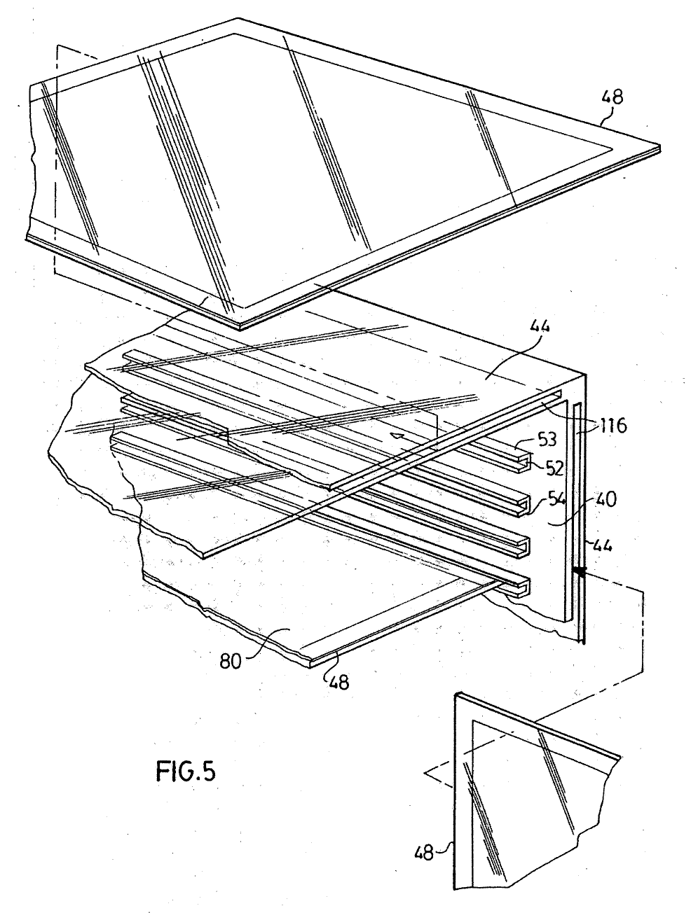

As shown in FIGS. 4 and 5, walls 30 to 38 contain a recess 116 with one access opening, which slideably receives and retains a panel 48 with its mounted artwork 68 for display. The walls 30 to 38 are constructed of clear transparent material such as glass or acrylic in order to provide viewable access to the panel 48 stored in the recess 116. The recess 116 preferably has a width of 0.4 inches, although the range of 0.2 inches to 0.5 inches can be used. The recess 116 preferably has a length and depth of 15 inches; however, it is to be understood that the size and dimension of the recess 116 corresponds to the size and dimension of the panel 48 to be positioned within the recess. Similarly, it can be appreciated that the panels 48 which fit into grooves 52 can also be fitted into the recess 116 on walls 30 to 38. However, it can be appreciated that specialized panels, which are similar in construction and principles to the panels 48, can be constructed for use with the recess 116.

Similarly, the cover member 18 can contain a recess 116 with one access opening, for slideably receiving and retaining a panel 48 with its mounted artwork 68, wherein the cover member 18 is constructed of clear transparent material such as glass or acrylic in order to provide viewable access to the panel 48 stored in the recess 116.

In both embodiments of the display and storage device 10, panel 48 is comprised of support substrate 70 for receiving the artwork 68, and at lease one cover sheet 80. The support substrate is preferably constructed from a stiff material such as paper, glass, plastic, metal, or wood. Each panel 48 has a shape and size similar to the contour of the inner cavity 22 of body member 14, as defined by the inner surface areas 40 of walls 30 and two opposing walls 32 and 36 or 34 and 38. Preferably, the panel 48 is 15 inches×15 inches in length and width, and it is to be understood that this dimension is dependent on the length and width of the inner cavity 22 of the display and storage device 10, and the depth of groove 52. Each panel 48 is preferably of a certain thickness to insure that the panel has sufficient stiffness to be self-supporting in both a vertical and horizontal orientation.

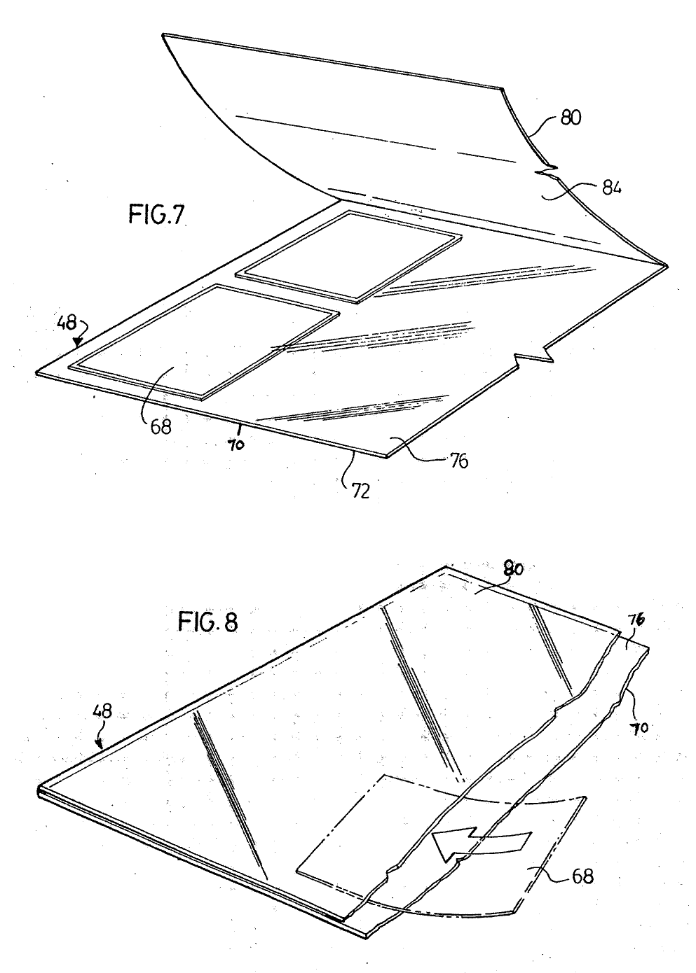

An embodiment of the panel 48 is illustrated in FIG. 7, wherein the support substrate 70 has a first face 72 and a second face 76. A plurality of artwork 68 can be removeably mounted onto the first face 72 or second face 76 or both faces 72 and 76 using conventional photo adhesive means, such as adhesive tape, photo corners, etc. Mounting the artwork 68 on both faces 72 and 76 increases the storage capacity and allows more selection of the artwork to be displayed. The cover sheet 80 comprises a conventional thin flexible transparent photo-safe film which is positioned and releaseably engages with face 76 of support substrate 70 to protect and hold the mounted artwork 68. Preferably, the cover sheet 80 has an inner surface area 84 and an outer surface area 88, wherein the inner surface area 84 is coated with a clear tacky adhesive material that is reusable, non-drying and pressure-sensitive. The cover sheet 80 has a shape similar to the shape of the first face 72 and second face 76 of support substrate 70, and is preferably smaller in dimension than the dimensions of the first face 72 and the second face 76. When the cover sheet 80 is in the open position, artwork 68 can be positioned or removed from the support substrate 70. Alternatively, one edge of the cover sheet 80 can be fixed to the support substrate 70. In a further preferred aspect, face 72 or 76, or both faces 72 and 76 of support substrate 70 can be coated with a clear tacky adhesive material that is reusable, non-drying and pressure-sensitive for removeably mounting the artwork 68, wherein a thin flexible transparent cover sheet 80 releaseably engages the support substrate 70 to protect the mounted artwork 68.

In a further embodiment of panel 48, the cover sheet 80 is preferably constructed from a stiff transparent material such as glass or plastic, which is positioned and abuts with support substrate 70 to protect and hold the mounted artwork 68. The support substrate 70 and the cover sheet 80 is removeably held together in the closed position by conventional means, such as magnets, snaps, screws, clips, clamps, hinges, etc., wherein the holding means is positioned along at least two ends of the cover sheet 80. In a further preferred aspect, the cover sheet 80 and the support substrate 70 is hingedly attached at one end of the panel 48. In the closed position, the inner surface area 84 of cover sheet 80 and the face 76 of support substrate 70 abut, wherein the support substrate 70 and the cover sheet 80 is removeably held together, along at least one unhinged end, by conventional means, such as magnets, snaps, screws, clips, clamps, hinges, etc. In yet a further aspect of the panel 48 as illustrated in FIG. 8, the inner surface area 84 of cover sheet 80 and the face 76 of support substrate 70 abut, wherein the cover sheet 80 and the support substrate 70 is fused at one end of the panel 48. The unfused ends of the support substrate 70 and the cover sheet 80 are tension-biased together. A plurality of artwork 68 can be removeably mounted between the inner face 84 of the cover sheet 80 and the face 76 of the support substrate 70. The unfused ends of the support substrate 70 and the cover sheet 80 can be removeably held together by conventional means, such as magnets, snaps, screws, clips, clamps, hinges, etc., wherein the holding means is positioned on at least one unfused end.

The panel 48 may be provided with suitable handles on at least one end (not shown) to facilitate the handling of the panels.

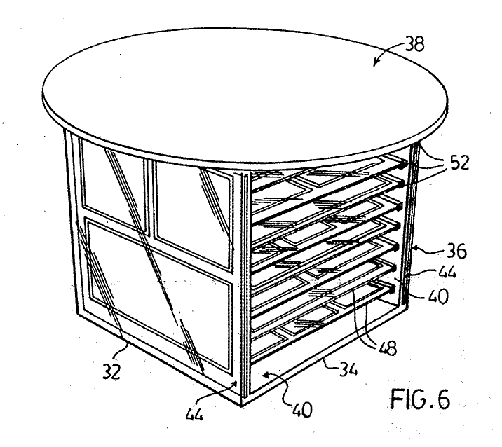

In a further alternate embodiment of the invention, as illustrated in FIG. 6, the walls 30 to 38 of the body member 14 can be a variety of shapes. Wall 38 is substantially circular in shape, wherein the edges of walls 32, 36, and 30 are attached to the inner surface area 40 of wall 38 by conventional means. In this alternate embodiment, the device serves as a table wherein wall 38 serves as the tabletop for the table.

In a further alternate embodiment (not shown), the body member 14 and cover member 18 is fabricated using a transparent material such as glass or acrylic in order to provide viewable access into the inner cavity 22 of body member 14. The transparent walls of body member 14 and cover member 18 allow occupants of the room to freely and conveniently view the artwork 68 mounted on the panels 48 immediately adjacent to the walls 30 to 38.

It can be appreciated that the size of the display and storage device 10 is not limited to any specific dimensions, however, it is preferable that the device 10 be sufficiently large to serve as a piece of functional or decorative furniture, such as a table. Furthermore, the shape of the display and storage device 10 is not limited to the box-like formation, and other shapes can be utilized and are considered within the scope of the invention. In addition, it can be appreciated that the body member 14 can be provided in a variety of shapes. Thus, the shape chosen for the body member 14 will determine the number of walls required. It can also be appreciated that the walls 30 to 38 can be provided in a variety of shapes, as illustrated in FIG. 6. Although body member 14 is preferably of a unitary construction, it is possible that body member 14 be comprised of segments which combine together. For example, the series of aligned grooves 52 can be fabricated on a separate sheet of suitable material, which can be positioned within the inner cavity 22 and affixed to the inner surface area 40 of the walls of the body member 14. Also, the outer surface area 44 of body member 14 and external surface area 56 of cover member 18 may be provided with conventional decorative finishes which enhance the decorative appearance of the display and storage device 10.

Each panel 48 is preferably of a certain thickness to insure that each panel is sufficiently stiff to be self-supporting in both a vertical and horizontal orientation.

Although various preferred embodiments of the present invention have been described herein in detail, it will be appreciated by those skilled in the art that variations may be made thereto without departing from the spirit of the invention or the scope of the appended claims.

1. A display and storage device for pictures, photographs, drawings and other artwork and printed matter, comprising:
a series of panels, wherein each panel removeably holds and displays at least one picture, photograph, drawing and other artwork and printed matter, and
a body member for housing the panels having an interior that forms a cavity, wherein the panels are removeably retained and supported in the cavity, and wherein at least one panel, together with its picture, photograph, drawing and other artwork and printed matter, is viewable through the body member,
wherein the means for housing serves as a piece of furniture.

2. A display and storage device in accordance to claim 1, wherein the means for housing includes a cover member.

3. A display and storage device in accordance to claim 1, further comprising panel retaining means for removeably retaining the panels in the cavity of the means for housing, wherein at least two edge portions of the panel engage the panel retaining means.

4. A display and storage device in accordance to claim 3, wherein the panels are positioned in a vertical orientation.

5. A display and storage device in accordance to claim 3, wherein the panels are positioned in a horizontal orientation.

6. A display and storage device for pictures, photographs, drawings and other artwork and printed matter, comprising:
a series of panels with a first and second face, wherein each panel removeably holds and displays at least one picture, photograph, drawing and other artwork and printed matter on each face,
a body member, comprising a plurality of walls defining at least one inner cavity and at least one access port, wherein the panels are removeably retained and supported in the inner cavity and wherein the panels are inserted and removed through the access port,
means for removeably retaining the panels in the inner cavity of the body member, comprising a series of aligned grooves in the inner cavity on two opposing walls of the body member, wherein each pair of aligned grooves slideably receives and supports a panel,
at least one wall of the body member having means for viewing at least one panel together with its picture, photograph, drawing and other artwork and printed matter,
wherein the display and storage device serves as a piece of furniture.

7. A display and storage device in accordance with claim 6, further comprising a cover member.

8. A display and storage device in accordance with claim 6, wherein each pair of matching aligned grooves slideably receives and engages the edge portions of a panel.

9. A display and storage device in accordance with claim 6, wherein at least one wall of body member is constructed of a transparent material.

10. A display and storage device in accordance with claim 9, wherein the wall of body member has a recess for slideably receiving a panel for display.

11. A display and storage device in accordance with claim 6, wherein at least one wall of body member has a panel retaining means affix to the outer surface area for receiving a panel for display.

12. A display and storage device in accordance with claim 6, wherein the panels are retained in a vertical orientation.

13. A display and storage device in accordance to claim 6, wherein the panels are retained in a horizontal orientation.

14. A display and storage device in accordance with claim 6 and 7, wherein the cover member is constructed of a transparent material.

15. A display and storage device in accordance with claim 14, wherein the cover member has a recess for slideably receiving a panel for display.

16. A display and storage device in accordance with claim 6 and 7, wherein the cover member has a panel retaining means affix to the outer surface area for receiving a panel for display.

17. A table having a top wall, at least two side walls, and a base wall having an interior that forms a cavity, comprising:
a series of panels, wherein each panel has removeably holds and displays at least one picture, photograph, drawing and other artwork and printed matter;
means for removeably retaining the panels in the cavity of the table; and
at least one wall is constructed of a transparent material;
wherein at least one panel together with its picture, photograph, drawing and other artwork and printed matter is viewable through at least one wall of the table.
